(19) United States
(12) Patent Application Publication
(10) Pub. No.: US 2023/0131426 A1
(43) Pub. Date: Apr. 27, 2023

(54) INFORMATION DISPLAY CONTROL DEVICE, INFORMATION DISPLAY CONTROL METHOD, AND RECORDING MEDIUM ON WHICH PROGRAM IS RECORDED

(71) Applicant: NEC Corporation, Minato-ku, Tokyo (JP)

(72) Inventors: Nana JUMONJI, Tokyo (JP); Chisato Sugawara, Tokyo (JP); Kazuki Inagaki, Tokyo (JP); Yosuke Kimura, Tokyo (JP)

(73) Assignee: NEC Corporation, Minato-ku, Tokyo (JP)

(21) Appl. No.: 17/910,316

(22) PCT Filed: Mar. 31, 2020
(86) PCT No.: PCT/JP2020/014877

§ 371 Date: Sep. 8, 2022

(51) Int. Cl. G01C 21/34; G01C 21/36

(52) U.S. Cl. CPC G01C 21/3492; G01C 21/367; G01C 21/3602; G01C 21/3647

(57) ABSTRACT

An information display control device according to an aspect of the present disclosure includes: at least one memory configured to store instructions; and at least one processor configured to execute the instructions to: acquire vehicle information including positions in each section on roads through which each of a plurality of vehicles has passed and times at which each of a plurality of vehicles has traveled the positions; generate, for each section on the roads, a map indicating traffic records calculated based on the vehicle information including a position on the section in a different mode according to elapsed time from a latest time included in the vehicle information including a position on the section; and cause a display means to display the map.

### TECHNICAL FIELD

The present disclosure relates to an information display control device, an information display control method, and a program.

### BACKGROUND ART

A system that collects road images captured by a vehicle and monitors traffic records and state of the road is known.

For example, PTL 1 discloses a device that causes a plurality of vehicles equipped with a drive recorder to travel, and acquires an image via a communication network using a road image taken by each of the vehicles and information such as time and position of imaging as imaging information. The image acquisition device analyzes the state of road based on the received imaging information. The technique of PTL 1 is used by an operator from a road management organization to grasp road conditions that allow traveling in a disaster-stricken area even during a disaster. In this case, the traffic records of the road are displayed on a map, for example, and presented to the operator.

### CITATION LIST

### Patent Literature

[PTL 1] WO 2015/129045 A

### SUMMARY OF INVENTION

### Technical Problem

When a disaster occurs, road conditions change from moment to moment. For example, in a case of typhoon or heavy rain, flooding of a road, a fallen tree or collapse of a utility pole, mudslide, or the like occurs, so that a passable road becomes not passable as time elapses from occurrence of a disaster. In this case, the operator of the road management organization needs to check up to which time point there are traffic records in order to grasp the road conditions in detail.

On the other hand, when the traffic records are displayed on the map, the traffic records at the current time or the specified time are generally displayed. Therefore, as described above, in a case where the road conditions change from moment to moment, in order to confirm up to which time point there are traffic records, the operator needs to check the change in the traffic records for each road section while repeating specification of time on the map. Therefore, in a case where the number of road sections as management targets is enormous, it is difficult to promptly grasp a time point at which there are traffic records for each section.

An object of the present disclosure is to provide an information display control device, an information display control method, and a program capable of solving the problems described above and quickly grasping a time point at which there are traffic records at each position after occurrence of a disaster or the like.

### SOLUTION TO PROBLEM

An information display control device according to one aspect of the present disclosure includes: an acquisition means configured to acquire vehicle information including positions in each section on roads through which each of a plurality of vehicles has passed and times at which each of a plurality of vehicles has traveled the positions;

and a control means configured to generate, for each section on the roads, a map indicating traffic records calculated based on the vehicle information including a position on the section in a different mode according to elapsed time from a latest time included in the vehicle information including a position on the section, and to cause a display means to display the map.

An information display method according to one aspect of the present disclosure includes: acquiring vehicle information including positions in each section on roads through which each of a plurality of vehicles has passed and times at which each of a plurality of vehicles has traveled the positions; generating, for each section on the roads, a map indicating traffic records calculated based on the vehicle information including a position on the section in a different mode according to elapsed time from a latest time included in the vehicle information including a position on the section; and causing a display means to display the map.

A recording medium according to one aspect of the present disclosure records a program for executing a process, the process including: acquiring vehicle information including positions in each section on roads through which each of a plurality of vehicles has passed and times at which each of a plurality of vehicles has traveled the position;

generating, for each section on the roads, a map indicating traffic records calculated based on the vehicle information including a position on the section in a different mode according to an elapsed time from a latest time included in the vehicle information including a position on the section; and causing a display means to display the map.

### Advantageous Effects of Invention

An effect of the present disclosure is that it is possible to quickly grasp a time point at which there are traffic records at each position after the occurrence of a disaster or the like.

### BRIEF DESCRIPTION OF DRAWINGS

FIG. 1 is a schematic diagram illustrating an outline of an information display system 10 according to a first example embodiment.

FIG. 2 is a block diagram illustrating an example of a configuration of an information display system 10 according to the first example embodiment.

FIG. 3 is an example of vehicle information in the first example embodiment.

FIG. 4 is a flowchart illustrating a traffic record display process in the first example embodiment.

FIG. 5 is an example of a map displayed on a display device 50 in the first example embodiment.

FIG. 6 is an example of displaying a traffic record on a map in the first example embodiment.

FIG. 7 is another example of displaying a traffic record on a map in the first example embodiment.

FIG. 8 is another example of displaying a traffic record on a map in the first example embodiment.

FIG. 9 is a flowchart illustrating image display process according to the first example embodiment.

FIG. 10 is an example of image display according to the first example embodiment.

FIG. 11 is another example of image display according to the first example embodiment.

FIG. 12 is a block diagram illustrating an example of a configuration of an information display control device 1 according to a second example embodiment.

FIG. 13 is a block diagram illustrating an example of a hardware configuration of a computer 500.

### EXAMPLE EMBODIMENT

Example embodiments will be described in detail with reference to the drawings. Note that, in the drawings and the example embodiments described in the description, the same reference numerals are given to the same components, and the description thereof will be omitted as appropriate.

### First Example Embodiment

A first example embodiment will be described.

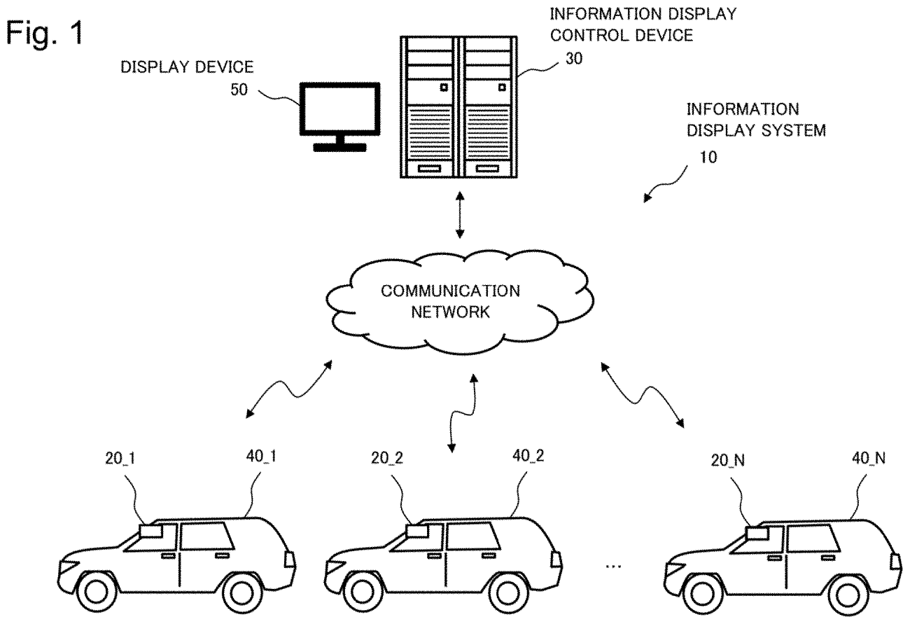

To start with, a configuration of an information display system according to the first example embodiment will be described. FIG. 1 is a schematic diagram illustrating an outline of the information display system 10 according to the first example embodiment. Referring to FIG. 1, the information display system 10 includes a plurality of imaging devices 20_1, 20_2, . . . 20_N (N is a natural number) (hereinafter, collectively also referred to as imaging devices 20), an information display control device 30, a plurality of vehicles 40_1, 40_2, . . . 40_N (N is a natural number) (hereinafter, collectively also referred to as vehicles 40), and a display device 50.

In the information display system 10, the imaging devices 20_1, 20_2, . . . 20_N are mounted on the vehicles 40_1, 40_2, . . . 40_N belonging to the road management organization, for example, such as a province autonomous community or a road management company, respectively. In the information display system 10, the information display control device 30 and the imaging devices 20_1, 20_2, . . . 20_N are connected, for example, in such a way that the communication network can be used for communication.

The information display control device 30 and the display device 50 are, for example, arranged in the road management organization described above. The information display control device 30 may be arranged in a place other than the road management organization described above. In this case, the information display control device 30 may be achieved by a cloud computing system.

In the present example embodiment, a case where the imaging devices 20 are mounted on the vehicles 50 will be described. In this case, the imaging devices 20 may be, for example, drive recorders mounted on the vehicles. The imaging devices 20 may be mounted on another moving body such as a bicycle or a drone, or a person may carry the imaging devices 20.

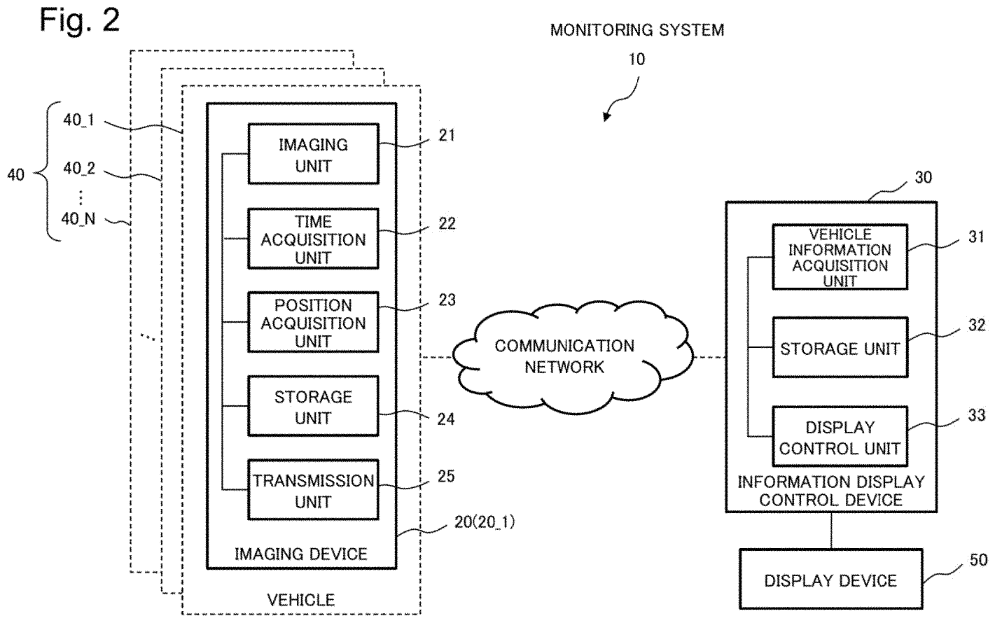

Next, a configuration of each device will be described with reference to FIG. 2. FIG. 2 is a block diagram illustrating an example of a configuration of an information display system 10 according to the first example embodiment.

(Configuration of Imaging Devices)

As illustrated in FIG. 2, the imaging devices 20 include an imaging unit 21, a time acquisition unit 22, a position acquisition unit 23, a storage unit 24, and a transmission unit 25.

The imaging unit 21 captures images around the vehicles 40. The imaging unit 21 captures images around the vehicles 40 at predetermined intervals while the vehicles 40 are traveling on a road. The images obtained by imaging may or may not include images of a surrounding road such as the front of the vehicles 40. The images obtained by imaging are images around the moving body in a case of a moving body in general, and are images around a person in a case of a person.

The time acquisition unit 22 acquires the time of the position through which the vehicles 40 have passed. The time acquisition unit 22 outputs an image capturing time to the imaging unit 21.

The position acquisition unit 23 acquires positions where the vehicles 40 are passing. The position acquisition unit 23 outputs positions where the vehicles 40 have passed to the imaging unit 21. The position acquisition unit 23 is, for example, a global positioning system (GPS) receiver, and may be included in the imaging unit 21 or may be a separate unit.

The imaging unit 21 stores the positions acquired by the position acquisition unit 23, the time acquired by the time acquisition unit 22 (the time at which the vehicles have passed through the positions), and the images captured by the imaging unit 21 (the images captured at that time) in the storage unit 24 as vehicle information in association with each other.

The storage unit 24 stores a vehicle identifier (ID). Furthermore, the storage unit 24 stores the vehicle information. The storage unit 24 is, for example, a random access memory (RAM).

The transmission unit 25 acquires the vehicle information from the storage unit 24, and transmits the vehicle information to the information display control device 30 via the communication network. For example, the transmission unit 25 may transmit the vehicle information including the images every time when the images are captured, or may transmit the vehicle information including each of one or more images captured in each period for each predetermined period.

(Configuration of Information Display Control Device)

The information display control device 30 includes a vehicle information acquisition unit 31, a storage unit 32, and a display control unit 33. The vehicle information acquisition unit 31 is an example embodiment of an acquisition unit in the present disclosure. The display control unit 33 is an example embodiment of a control unit in the present disclosure. Some or all of the components of the information display control device 30 may be achieved by the cloud computing system as described above. For example, the vehicle information acquisition unit 31 and the storage unit 32 may be arranged on a cloud, and the display control unit 33 may be arranged in the road management organization.

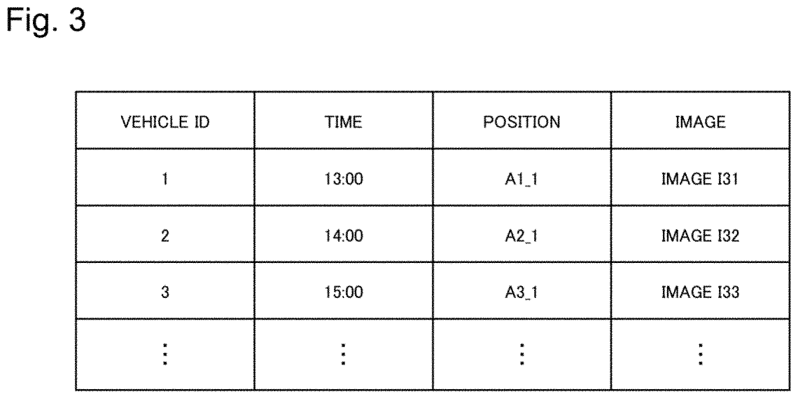

The vehicle information acquisition unit 31 acquires the vehicle information transmitted from the imaging devices 20 of the vehicles 40. FIG. 3 is an example of vehicle information in the first example embodiment. As described above, the vehicle information includes the vehicle ID, the positions where the vehicles have passed, the time when the vehicles have passed through the positions, and the images captured at that time. In a case where the imaging devices 20 transmit the vehicle information every time when an image is captured, the vehicle information acquisition unit 31 may set the time when the vehicle information is received as the time of the vehicle information, instead of the imaging devices 20 setting the time when the vehicles have passed through the positions as the vehicle information.

Referring to FIG. 3, the vehicle information stores, for example, a vehicle ID “1”, a time “13:00”, a position “A1_1”, and an image “image 131” captured at that time. The vehicle information acquisition unit 31 stores the vehicle information in the storage unit 32.

The storage unit 32 stores the vehicle information acquired by the vehicle information acquisition unit 31. Maps are stored in advance in the storage unit 32. The maps are, for example, maps of an area managed by the road management organization.

The display control unit 33 displays the maps stored in the storage unit 32 on the display device 50. The display control unit 33 acquires the vehicle information from the storage unit 32. The display control unit 33 indicates the traffic records on the maps displayed on the display device 50 by using the positions and the time included in each piece of vehicle information.

The display control unit 33 determines the traffic records for each road section of a predetermined length as described later, for example. The display control unit 33 may determine the traffic records for each position included in the vehicle information received from each vehicle 40. The display control unit 33 may determine the traffic records for each mesh obtained by dividing an area on a map into mesh shapes based on positions (latitude and longitude) included in the vehicle information. The display control unit 33 indicates the traffic records on the maps by, for example, superimposing a predetermined graphic such as a rectangle or a predetermined line segment such as a thick line on the road of the map. The display control unit 33 may superimpose the predetermined graphic or the predetermined line segment at a position along a road other than the road as long as the traffic records can be indicated on the map.

The display control unit 33 changes the display mode of the traffic records on the map according to the elapsed time from the time of the latest vehicle information. Here, the display control unit 33 changes, for example, at least one of size, color, and transmittance of the predetermined graphic described above that indicates the traffic records, or at least one of thickness, color, and transmittance of the predetermined line segment. Moreover, in a case where the elapsed time from the time of the latest vehicle information is equal to or more than a predetermined value, the display control unit 33 deletes the predetermined graphic or the predetermined line segment. When the elapsed time from the time of the latest vehicle information is equal to or more than a predetermined value, the display control unit 33 may change the predetermined graphic or line segment to a different graphic or line segment.

Furthermore, when any road section whose traffic records are indicated on the map is specified, the display control unit 33 displays the images included in the vehicle information of the road section on the display device 50. When there is a plurality of images with different times for the specified road section, the display control unit 33 may display the plurality of images on the display device 50 in a time series. When displaying the images on the display device 50, the display control unit 33 may display the time associated with the images together.

The display device 50 is, for example, a display. The display device 50 displays the map or the images indicating the traffic records according to the control of the display control unit 33.

Next, operations of the first example embodiment will be described.

(Traffic Records Display Process)

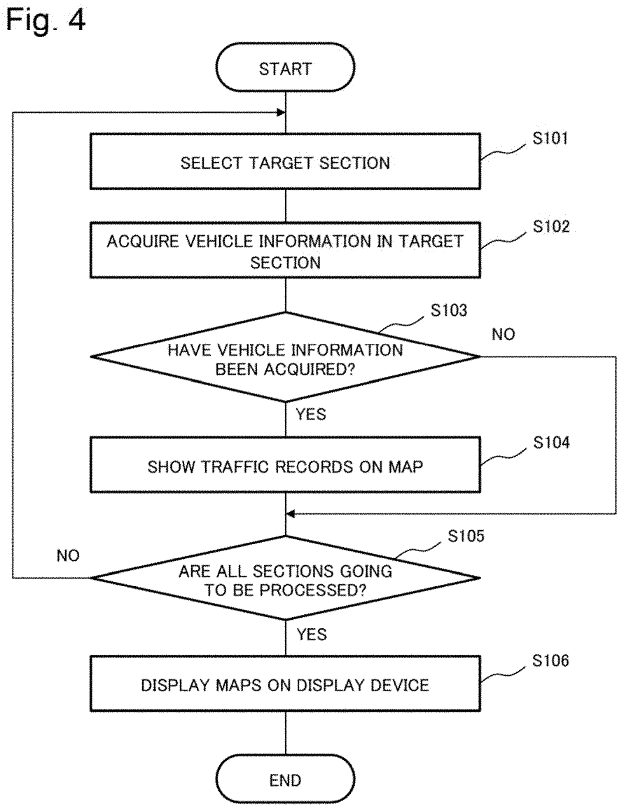

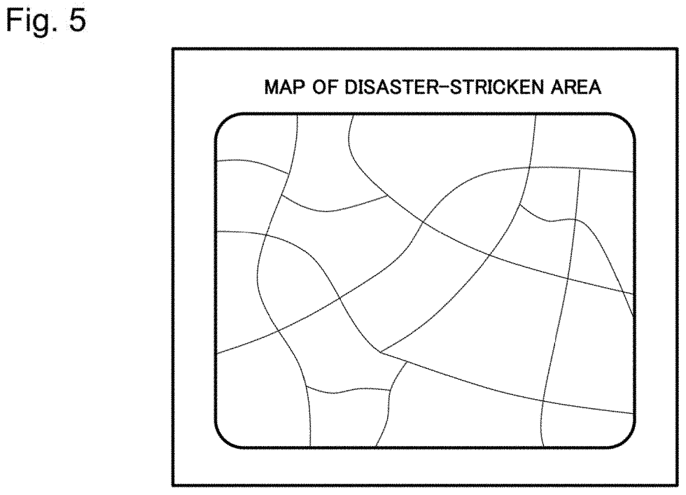

The traffic record display process in the information display system 10 will be described with reference to FIGS. 4 and 5.

FIG. 4 is a flowchart illustrating a traffic record display process in the first example embodiment. The traffic record display process may be automatically executed by the information display control device 30, for example, at any timing after the occurrence of a disaster, or may be executed in response to an instruction of an operator.

In the following description of the traffic record display process, it is assumed that the storage unit 32 stores the vehicle information as illustrated in FIG. 3 acquired by the vehicle information acquisition unit 31. In addition, it is assumed that the storage unit 32 stores the map as illustrated in FIG. 5. FIG. 5 is an example of a map displayed on the display device 50 in the first example embodiment. Here, it is assumed that each road in the map to be managed is divided into sections of a predetermined length (for example, several 10 meters or several 100 meters). Positions “A1_1”, “A2_1”, and . . . in FIG. 3 are positions included in the sections “A1” and “A2”, respectively.

The display control unit 33 of the information display control device 30 selects a target section to be processed (hereinafter, also referred to as target section) from among the sections on the road on the map (S101). The display control unit 33 acquires, from the storage unit 32, the vehicle information of the target section in a time zone to be targeted (hereinafter, also referred to as a target time zone) in which the traffic records are displayed (S102). Here, the target time zone is, for example, a time zone specified by the operator from a disaster occurrence time to the current time. The vehicle information in the target time zone is vehicle information in which the time included in the vehicle information is included in the target time zone. The vehicle information of the target section is vehicle information in which a position included in the vehicle information is included in the target section. The display control unit 33 may acquire the vehicle information of the vehicles 40 that have moved at a constant speed or more among the vehicle information of the target section in a position target time zone. The vehicles 40 that have moved at a constant speed or more can be extracted based on the vehicle ID, the position, and the time included in the vehicle information.

In step S102, when the vehicle information cannot be acquired (step S103/NO), the display control unit 33 determines that there is no traffic records in the target section in the target time zone, and proceeds to the processing of step S105.

In step S103, when the vehicle information have been acquired (step S103/YES), the display control unit 33 determines that there are traffic records at the target position in the target time zone.

The display control unit 33 indicates the traffic records at the target position in the target section on the map (S104). Here, the display control unit 33 indicates the traffic records in different modes according to the elapsed time from the latest time included in the vehicle information of the target section.

The display control unit 33 repeats a process from step 5101 for all sections of the road on the map (step S105), thereby generating a map indicating the traffic records.

The display control unit 33 causes the display device 50 to display the map (the generated map) showing the traffic records (step S106).

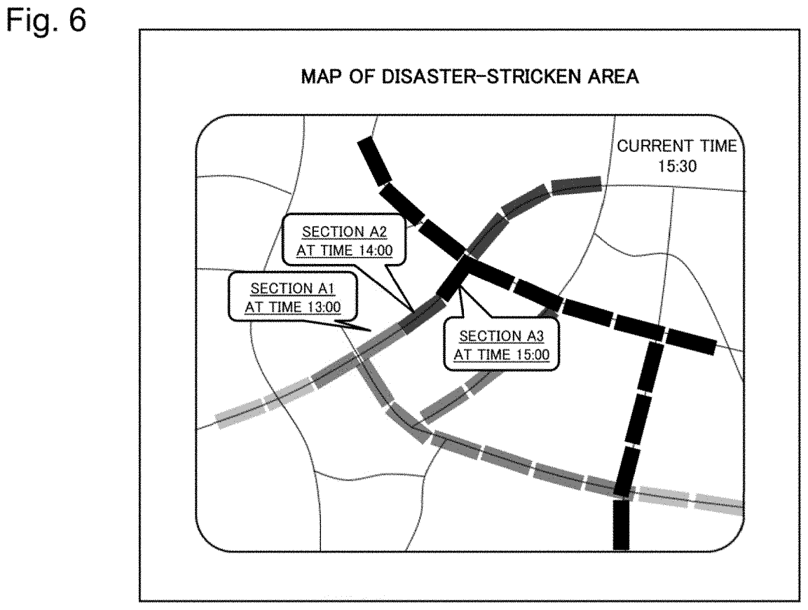

FIGS. 6 to 8 are examples of maps displayed on the display device 50 in the first example embodiment.

FIG. 6 is an example of a case where the traffic record display process is executed at the current time 15:30.

For example, it is assumed that the traffic record display process is executed at the current time 15:30 with the target time zone set to 13:00 to 15:30. In this case, the display control unit 33 determines that there are traffic records in the target time zone in sections A1, A2, and A3 based on the vehicle information of FIG. 3. Here, the latest times included in the vehicle information of the sections A1, A2, and A3 are respectively 13:00, 14:00, and 15:00.

For example, as illustrated in FIG. 6, the display control unit 33 superimposes a bold line (thick line) thicker than the thickness of a line indicating a road on a road section where there are traffic records. Then, the display control unit 33 changes the transmittance of the thick line to be superimposed according to the number of times since the first time has elapsed from the latest time included in the vehicle information. Furthermore, when the second time has elapsed from the latest time included in the vehicle information even when there are traffic records, the display control unit 33 deletes the thick line (not to be superimposed).

Here, the first time is 1 hour, and the second time is 4 hours. The transmittance of the thick line indicating the traffic records is set to four levels of 0% (less than one hour from the last reception time), 25% (one hour or more and less than two hours), 50% (two hours or more and less than three hours), and 75% (three hours or more) according to the number of times since the first time has elapsed (0, 1, 2, 3). The second time is set to four hours.

As illustrated in FIG. 6, the display control unit 33 causes the display device 50 to display maps in which the traffic records of the sections A1, A2, and A3 for which 2.5 hours, 1.5 hours, and 0.5 hours have elapsed from the latest time included in the vehicle information are respectively indicated by thick lines with transmittances of 50%, 25%, and 0%.

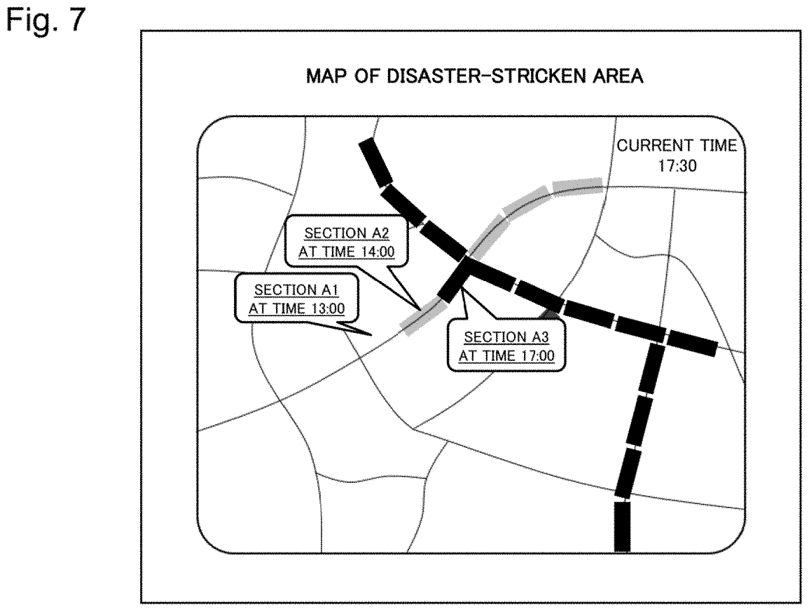

FIG. 7 is an example of a case where the traffic record display process is further executed at the current time 17:30.

For example, it is assumed that the traffic record display process is executed at the current time 17:30 with the target time zone set to 13:00 to 17:30. In this case, for example, the display control unit 33 determines that there are traffic records in the target time zones in the sections Al, A2, and A3 based on the vehicle information. Here, it is assumed that the latest times included in the vehicle information of the sections A1, A2, and A3 are respectively 13:00, 14:00, and 17:00.

As illustrated in FIG. 7, the display control unit 33 deletes the thick lines superimposed on the section A1 in which 4.5 hours have elapsed from the latest time included in the vehicle information, generates the maps in which the traffic records of the sections A2 and A3 in which 3.5 hours and 0.5 hours have elapsed are respectively indicated by the thick lines having transmittances of 75% and 0%, and displays the maps on the display device 50.

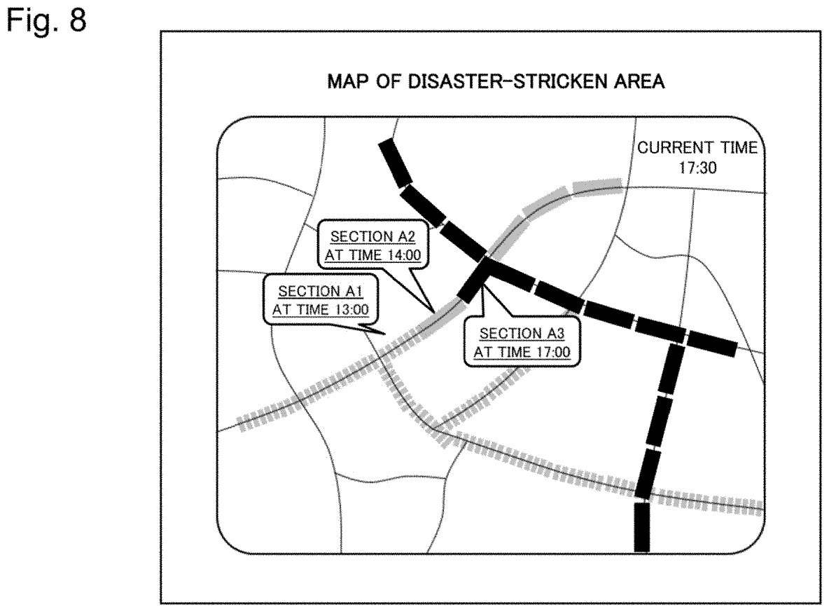

FIG. 8 is another example of a case where the traffic record display process is executed at the current time 17:30.

As illustrated in FIG. 8, when the second time has elapsed from the latest time included in the vehicle information, the display control unit 33 may indicate the traffic records by a line other than the thick line instead of deleting the thick line (not to be superimposed).

In the example of FIG. 8, as illustrated in FIG. 8, the display control unit 33 superimposes a broken line on a section A1 in which 4.5 hours have elapsed from the latest time included in the vehicle information.

With this configuration, it is possible to easily grasp that there is past vehicle information even in a section in which the second time has elapsed from the latest time included in the vehicle information.

In the description of the traffic record display process described above, as illustrated in FIGS. 6 to 8, the traffic records before the second time elapses is indicated by a thick line, but other line segments or graphics other than the thick line may be used as long as the elapsed time can be indicated by a different thickness (size), color, and transparency. The traffic records after the second time has elapsed is indicated by the broken line, but other line segments or graphics other than the broken line may be used as long as the traffic records are different from that before the second time elapses.

(Image Display Process)

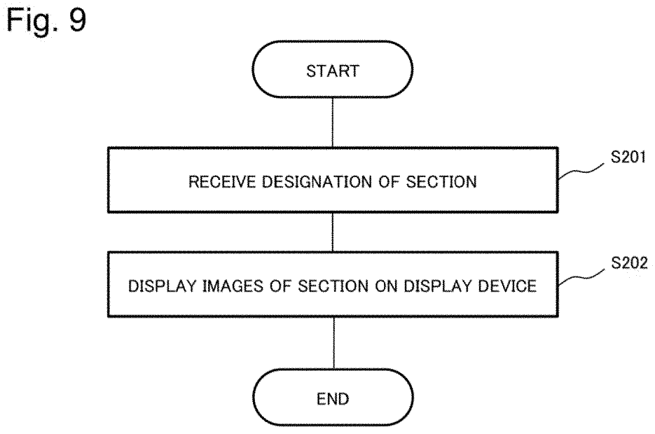

Next, the image display process in the information display system 10 will be described with reference to FIG. 9.

FIG. 9 is a flowchart illustrating the image display process according to the first example embodiment. The image display process is executed following the traffic record display process.

The information display control device 30 receives section specification to be targeted that checks the images from the operator or the like (step S201). Here, the operator or the like specifies a section in which the traffic records are indicated on the map displayed on the display device 50.

The display control unit 33 causes the display device 50 to display the images included in the vehicle information regarding a specified section (step S202).

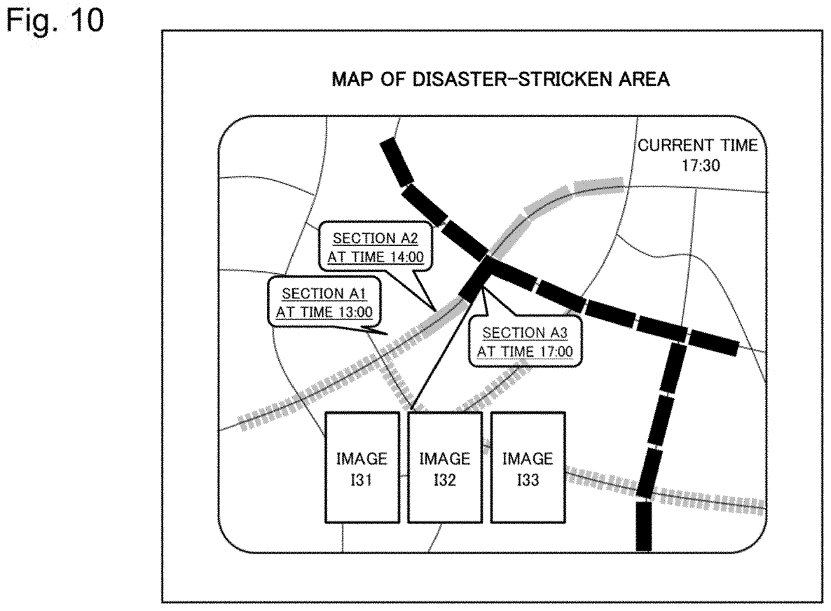

FIG. 10 is an example of image display according to the first example embodiment. For example, it is assumed that the operator or the like has specified the section A3 when the map of FIG. 8 is displayed. In the section A3, for example, it is assumed that the vehicle information at times of 15:00, 16:00, and 17:00 includes an image 131, an image 132, and an image 133, respectively. In this case, for example, as illustrated in FIG. 10, the display control unit 33 displays the images 131 to 133 in a time series. In FIG. 10, the images 131 to 133 are displayed as thumbnails on the map. For example, when the operator specifies any of the images, the display control unit 33 may cause the display device 50 to display the image in an enlarged manner. The images of the specified section may be enlarged images instead of thumbnails. The enlarged images may be displayed on the entire screen of the display device 50, for example. In this case, for example, the display control unit 33 may display marks such as arrows at right end and left end of the image, and display the preceding and following images in a time series by clicking the marks.

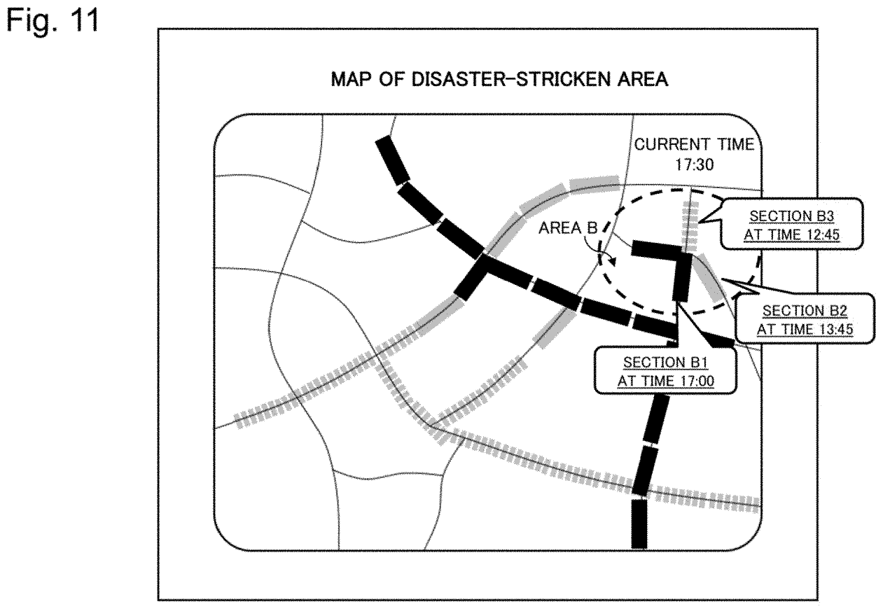

FIG. 11 is another example of image display according to the first example embodiment. In the example of FIG. 11, at an intersection of a section B, the traffic records of three different display modes are illustrated adjacent to each other. Here, as illustrated in FIG. 11, the traffic records of sections B1 and B2 in which 0.5 hours and 3.75 hours have elapsed from the latest time included in the vehicle information are respectively indicated by the thick lines having a transmittance of 0% and 75%. The traffic records of the section B3 in which 4.75 hours have elapsed are indicated by the broken line.

For example, the operator that has referred to the traffic records as illustrated in FIG. 11 can figure out that cause of traffic congestion in the section B1 is near the intersection, considering that there has been no traffic of vehicles 40 in the section B3 for four hours or more and there has been no traffic of vehicles 40 in the section B2 for three hours or more in the section B. For example, during disaster, the operator can quickly grasp until when the vehicle can pass by simply checking the traffic records on the map without specifying the time.

Accordingly, the operation of the first example embodiment is completed.

In the first example embodiment, the display control unit 33 indicates the traffic records of each section on the map based on the vehicle information. The display control unit 33 may further indicate a congestion situation of each section at the current time or the specified time on the map. In this case, for example, the display control unit 33 calculates a moving speed of each vehicle 40 based on the vehicle information in a predetermined period including the current time and the specified time in each section, and performs statistical processing such as calculation of an average value to determine the congestion situation. The display control unit 33 may use congestion information acquired from a site or the like that distributes the congestion information. Then, the display control unit 33 displays, on each section on the map, the predetermined graphic and the predetermined line segment indicating the congestion together with the traffic records in a mode according to the congestion situation, and causes the display device 50 to display the graphic and the line segment. The display control unit 33 may represent the passage of time by changing at least one of the size, color, and transmittance of the predetermined graphic or the predetermined line segment indicating the congestion, similarly to the display mode of the traffic records. In addition to the congestion, the display control unit 33 may also display information related to obstacles such as “U-turn” or “lane change” acquired from the vehicle information or the like.

In the first example embodiment, the display mode of the traffic records has been changed according to the elapsed time to the starting point from the latest time included in the vehicle information as the starting point, but a slide bar that specifies the time as the starting point may be provided on the screen displayed by the display control unit 33, and the display mode of the traffic records and the congestion information until the specified time may be changed.

Next, effects of the first example embodiment will be described.

According to the first example embodiment, it is possible to quickly grasp data acquired after the occurrence of a disaster. The reason is that the information display control device 30 acquires the vehicle information including a position in each road section through which each of the plurality of vehicles 40 has passed and a time at which each of the plurality of vehicles has traveled the positions, and generates, for each road section, the map indicating the traffic records calculated based on the vehicle information including the position on the section in a different mode according to the elapsed time from the latest time included in the vehicle information including the position on the section, and displays the map on the display device 50.

According to the first example embodiment, by displaying the congestion information together with the traffic records, it is possible to suggest a place that should be preferentially handled to the operator.

### Second Example Embodiment

A second example embodiment will be described.

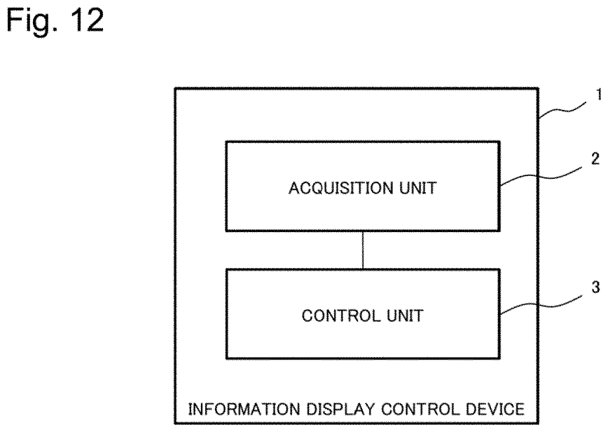

FIG. 12 is a block diagram illustrating an example of a configuration of an information display control device 1 according to the second example embodiment.

The information display control device 1 includes an acquisition unit 2 and a control unit 3. The acquisition unit 2 acquires the vehicle information that includes the positions that each of the plurality of vehicles has passed in each road section and the times at which each of the plurality of vehicles has traveled the positions. For each road section, the control unit 3 generates, for each road section, a map indicating the traffic records calculated based on the vehicle information that includes the positions of the section in a different mode according to the elapsed time from the latest time included in the vehicle information including the positions of the section, and causes the display device that is not illustrated to display the map.

According to the second example embodiment, it is possible to rapidly grasp the positions in time at which traffic records have been obtained for each position after the occurrence of a disaster or the like. This is because the information display control device 1 acquires the vehicle information including the positions in each road section through which each of a plurality of vehicles has passed and the times at which each of the plurality of vehicles has traveled through the positions; and generates, for each road section, the map indicating traffic records calculated based on the vehicle information including the position on the section in a different mode according to the elapsed time from the latest time included in the vehicle information including the position on the section, and causes a display device that is not illustrated to display the map.

(Hardware Configuration)

In each of the example embodiments described above, each component of each device (the imaging devices 20, the information display control device 30, and the like) indicates a block of a functional unit. A part or all of each component of each device may be achieved by any combination of the computer 500 and the program.

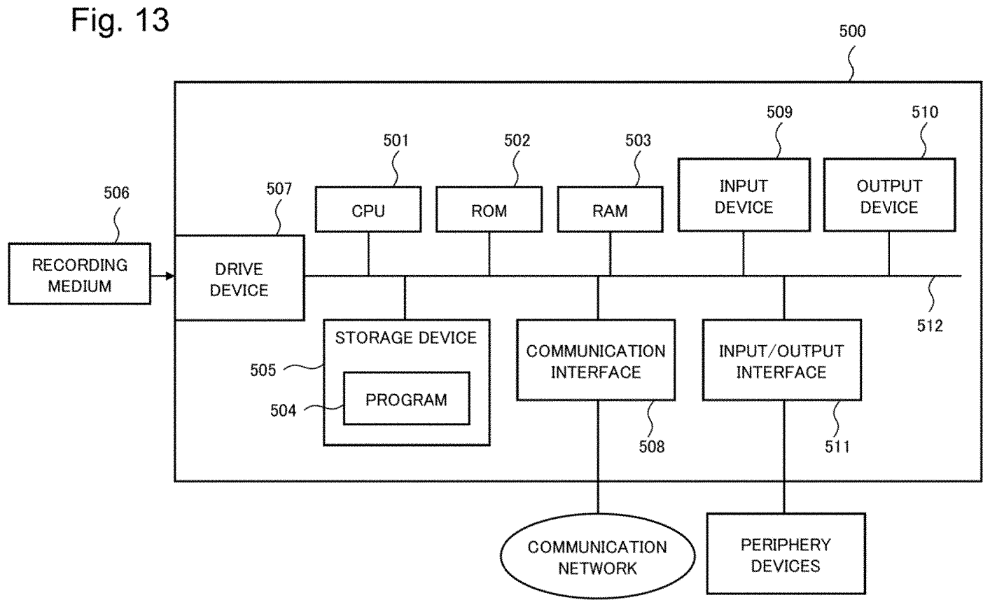

FIG. 13 is a block diagram illustrating an example of a hardware configuration of a computer 500. Referring to FIG. 13, the computer 500 includes, for example, a central processing unit (CPU) 501, a read only memory (ROM) 502, a random access memory (RAM) 503, a program 504, a storage device 505, a drive device 507, a communication interface 508, an input device 509, an output device 510, an input/output interface 511, and a bus 512.

The program 504 includes instructions for realizing each function of each device. The program 504 is stored in advance in the ROM 502, the RAM 503, and the storage device 505. The CPU 501 enables each function of each device by executing instructions included in the program 504. For example, the CPU 501 of the information display control device 30 executes the instructions included in the program 504 to enable the functions of the vehicle information acquisition unit 31 and the display control unit 33. For example, the RAM 503 of the information display control device 30 may store the data of the storage unit 32.

The drive device 507 reads and writes a recording medium 506. The communication interface 508 provides an interface with the communication network. The input device 509 is, for example, a mouse, a keyboard, or the like, and receives an input of information from an operator or the like. The output device 510 is, for example, a display, and outputs (displays) information to an operator or the like. The input/output interface 511 provides an interface with peripheral devices. The bus 512 connects the components of the hardware. The program 504 may be supplied to the CPU 501 via the communication network, or may be stored in the recording medium 506 in advance, read by the drive device 507, and supplied to the CPU 501.

The hardware configuration illustrated in FIG. 13 is an example, and other components may be added or some components may not be included.

There are various modifications of the realization methods of each device. For example, each device may be achieved by any combination of a computer and a program different in each component. A plurality of components included in each device may be achieved by any combination of one computer and a program.

A part or all of components of each device may be achieved by general-purpose or dedicated circuitry including a processor or the like, or a combination thereof. These circuitries may be configured by a single chip or may be configured by a plurality of chips connected via a bus. A part or all of components of each device may be achieved by a combination of the circuitry described above or the like and a program.

In a case where a part or all of components of each device is achieved by a plurality of computers, circuits, and the like, the plurality of computers, circuits, and the like may be arranged in a centralized manner or in a distributed manner.

The information display control device 30 may be disposed in the vehicles 40, or may be disposed at a place different from the vehicles 40 and connected to the imaging devices 20 via the communication network.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

### Reference signs List

1, 30 Information display control device
2 Acquisition unit
3 Control unit
10 Information display system
20 Imaging device
21 Imaging unit
22 Time acquisition unit
23 Position acquisition unit
24, 32 Storage unit
31 Vehicle information acquisition unit
33 Display control unit
40 Vehicle
500 Computer
501 CPU
502 ROM
503 RAM
504 Program
505 Storage device
506 Recording medium
507 Drive device
508 Communication interface
509 Input device
510 Output device
511 Input/output interface
512 Bus

What is claimed is:

1. An information display control device comprising:
at least one memory configured to store instructions; and
at least one processor configured to execute the instructions to:
acquire vehicle information including positions in each section on roads through which each of a plurality of vehicles has passed and times at which each of a plurality of vehicles has traveled the positions;
generate, for each section on the roads, a map indicating traffic records calculated based on the vehicle information including a position on the section in a different mode according to elapsed time from a latest time included in the vehicle information including a position on the section; and
cause a display means to display the map.

2. The information display control device according to claim 1, wherein the at least one processor is further configured to execute the instructions to:
indicate the traffic records in each section in a predetermined time zone before the current time by a predetermined graphic or a predetermined line segment superimposed on the section on the map, and
change at least one of size, color, and transmittance of the predetermined graphic or at least one of a thickness, color, and transmittance of the predetermined line segment according to elapsed time from a latest time included in the vehicle information of each section.

3. The information display control device according to claim 2, wherein the at least one processor is further configured to execute the instructions to:
delete the predetermined graphic or the predetermined line segment superimposed on the section when the elapsed time from the latest time included in the vehicle information of each section is equal to or more than a predetermined value.

4. The information display control device according to claim 2, wherein the at least one processor is further configured to execute the instructions to:
change a graphic or a line segment superimposed on the section to a graphic or a line segment different from the predetermined graphic or line segment when the elapsed time from the latest time included in the vehicle information at each position is equal to or more than a predetermined value.

5. The information display control device according to claim 1 wherein
the vehicle information includes images captured at positions where the vehicle is traveling, and
wherein the at least one processor is further configured to execute the instructions to:
cause the display means to display images included in the vehicle information including positions on a specified section.

6. The information display control device according to claim 5, wherein the at least one processor is further configured to execute the instructions to:
cause the display means to display images included in a plurality of pieces of the vehicle information including positions on the specified section in time series based on times included in each of the plurality of pieces of the vehicle information.

7. The information display control device according to claim 1, wherein the at least one processor is further configured to execute the instructions to:
in addition to traffic records of each position, cause the display means to display a map indicating congestion situation of the position based on the vehicle information.

8. An information display method comprising:
acquiring vehicle information including positions in each section on roads through which each of a plurality of vehicles has passed and times at which each of a plurality of vehicles has traveled the positions;
generating, for each section on the roads, a map indicating traffic records calculated based on the vehicle information including a position on the section in a different mode according to elapsed time from the latest time included in the vehicle information including a position on the section; and
causing a display means to display the map.

9. A non-transitory recording medium recording a program for executing a process, the process comprising:
acquiring vehicle information including positions in each section on roads through which each of a plurality of vehicles has passed and times at which each of a plurality of vehicles has traveled through the positions;
generating, for each section on the roads, a map indicating traffic records calculated based on the vehicle information including a position on the section in a different mode according to elapsed time from the latest time included in the vehicle information including a position on the section; and
causing a display means to display the map.
